(19) United States
(12) Patent Application Publication
(10) Pub. No.: US 2014/0352369 A1
(43) Pub. Date: Dec. 4, 2014

(54) METHOD AND DEVICE FOR REALIZING AN ELECTRICAL BICYCLE LOCK

(71) Applicant: Gregor DASBACH, Reutlingen (DE)

(72) Inventor: Gregor DASBACH, Reutlingen (DE)

(73) Assignee: ROBERT BOSCH GMBH, Stuttgart (DE)

(21) Appl. No.: 14/295,413

(22) Filed: Jun. 4, 2014

(30) Foreign Application Priority Data
Jun. 4, 2013 (DE) 10 2013 210 358.1

(51) Int. Cl. E05B 71/00

(52) U.S. Cl. CPC E05B 71/00
USPC 70/15

(57) ABSTRACT

A device and a method for theft protection of a bicycle are described, as well as a bicycle equipped with such a device or such a method. A control unit is provided, with the aid of which a locking device is able to be electrically activated in order to block at least the rotation of one wheel of a bicycle. Furthermore, a detection unit is provided, which additionally detects to what extent blocking of the wheel by the locking device is able to take place to begin with. The locking device is electrically activated, i.e., operated, only if blocking of the wheel, e.g., by means of a movable blocking element of the locking device, is actually also possible.

### FIELD OF THE INVENTION

The present invention relates to a method and an anti-theft device for a bicycle, and it also relates to a bicycle which is equipped with such a method or a corresponding device.

### BACKGROUND INFORMATION

Various types of vehicle locks for securing bicycles from theft are known already. For example, in addition to bicycle locks that can be mounted on the bicycle frame retroactively with the aid of a corresponding mount, permanently installed locks are used as well. While separate bicycle locks have the advantage of being usable individually, for example by chaining them to a stationary object, permanently installed locks allow rapid handling.

When using an electric bicycle, it is furthermore also possible to utilize the electrification of the bicycle as theft protection. For example, German Published Patent Appln. No. 10 2005 041 269 describes a locking device in the form of a frame lock provided with a movable locking bar, which is able to be electrically secured against unlocking via a blocking device.

However, when a permanently installed bicycle lock is used for the locking, a situation may arise in which the locking element hits a spoke and the locking process is blocked as a result. German Published Patent Appln. No. 101 33 080 describes a device in which an opening or an opening restriction for the blocking element is checked following a locking instruction, and the locking process is postponed until an opening is available. However, this has the disadvantage that locking possibly fails to take place when the bicycle is parked, yet an electric locking request is present over a longer period of time.

### SUMMARY

The present invention relates to a device and to a method for theft protection of a bicycle, and to a bicycle equipped with such a device or such a method. A control unit is provided, which can be used to electrically activate a locking device in order to block at least the rotation of one wheel of a bicycle. Furthermore, a detection unit is provided, which additionally detects to what extent blocking of the wheel by the locking device is able to be implemented in the first place. The core of the present invention concerns the fact that the locking device is electrically activated, i.e., operated, only after blocking of the wheel e.g., by means of a movable blocking element of the locking device, is actually also able to take place.

The advantage of the device according to the invention or the related method is that an electrical locking request exists only when locking of the locking device is actually also able to occur. This avoids unnecessary actuations or holding times of the actuator situated in the locking device, so that energy is saved in the operation.

To detect the locking possibility of the locking device, and thus also the blocking possibility of the wheel, a check of the travel to be overcome by the movable locking element in the locking device for the blocking is performed. The blocking element, for example, may be a locking bar, a bolt or a bracket that is able to be moved with the aid of an electromechanical device.

When using the device of the present invention on a two-wheeler or a bicycle, the situation regularly arises that the blocking element of the locking device cannot be inserted into the lock opening provided for this purpose, because an obstacle, e.g., a spoke of the wheel, is in the way. In such a case, a corresponding unit detects the obstacle and prevents the actuation for implementing the locking process. The driver of the two-wheeler may optionally be informed, e.g., via a display connected to the control unit or by an acoustic warning, so that the driver is aware of the unsecured bicycle. Instead, the actuation takes place, i.e., the the locking process is initiated, only if it has been determined that no obstacle, i.e., also no spoke, is situated along the path of the blocking element into the closing position.

In one development of the present invention, the locking device has an electrically controllable and thus activatable operating device, which is realized by a motor, a spindle, a spring or a magnet, for example. This actuating device makes it possible to move the blocking element in order to lock and/or open the locking device.

In one special further development of the invention, if an obstacle, especially a spoke, is detected in the path of the blocking element to the closing position, a drive unit installed on the bicycle rotates the wheel of the bicycle in such a way that locking becomes possible. Such drive units, for example, are mounted on the front wheel, the rear wheel or in the area of the foot pedal of electric bicycles. Since the rotation of the wheel is meant to merely move the obstacle or the spoke out of the way of the blocking element, no particularly high or lengthy drive torque is required. In the same way, the short movement of the entire bicycle is negligible because the wheel typically needs to be moved only briefly and by less than a few centimeters. If the check of the most advantageous locking position for the blocking element already takes place when the bicycle is parked, the driver will usually not be aware of this short additional movement.

As an alternative, it may also be the case, for example, that the motor generates a type of rocking step during the parking operation, so that the wheel and thus also the bicycle moves slightly back and forth for a brief moment, so that an optimal locking position can be found.

### BRIEF DESCRIPTION OF THE DRAWINGS

FIG. 1 shows a frame lock by way of example, which is used to illustrate the present invention.

FIG. 2 shows a block diagram schematically showing the realization of the invention as a (control) method.

### DETAILED DESCRIPTION

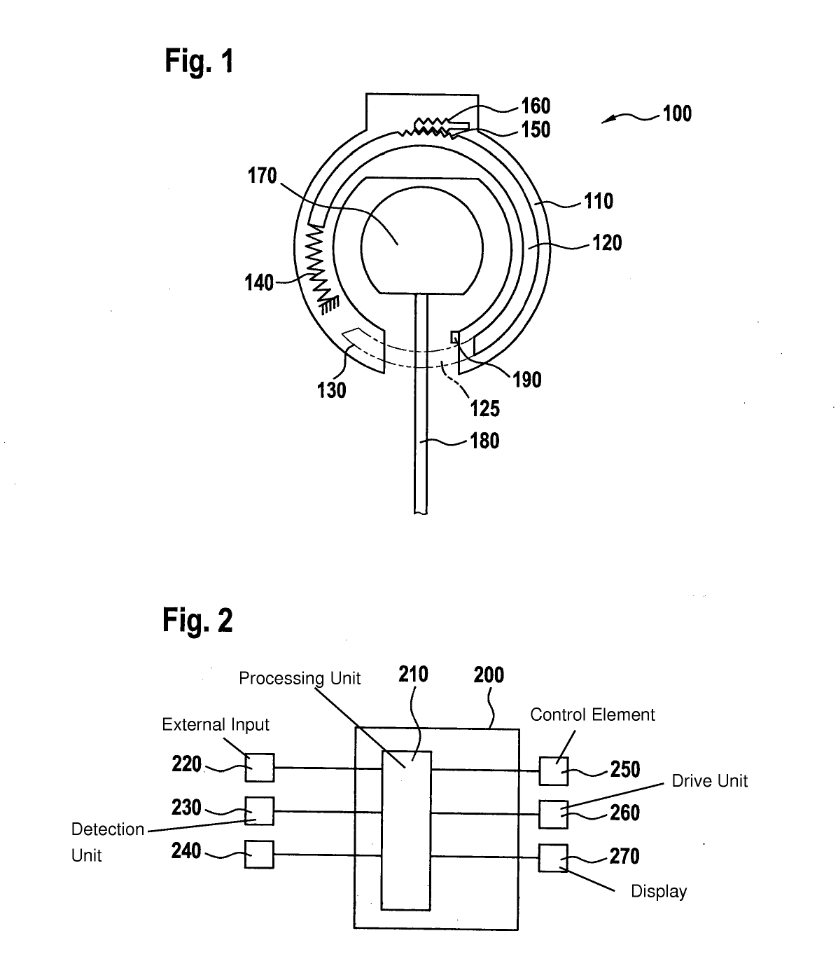

In general, the present invention is able to be used in a multitude of different designs of (bicycle) locks, in which a movable blocking element is employed to block a wheel of a bicycle. According to FIG. 1, the present invention is illustrated on the basis of a frame lock, but other bicycle locks, especially locks that are not permanently installed on the bicycle, may be equipped with the invention as well.

As shown in FIG. 1, a typical locking device as illustrated in the form of a frame lock 100 is situated around a tire 170 of a wheel. A movable blocking element or a locking bar 120, which is rotationally mounted in the exemplary embodiment at hand, is provided in housing 110 of frame lock 100. In the locked state of frame lock 100, this locking bar 120 is rotated into position 125 and inserted or snapped into place in a corresponding opposite lying receptacle 130 of housing 110. Housing 110 and locking bar 125 completely enclose tire 170 in the closed state, so that the movement of the associated wheel is blocked. A spring 140 may optionally be provided to unlock or open the lock, so that only the snap-in connection in receptacle 130 must be released in order to return locking bar 120 to its original position.

According to the present invention, a locking device shown in FIG. 1 by way of example includes a control element 160, such as an actuator, which is able to be operated electrically and moves blocking element 120 into the blocking position, or moves it from the blocking position back to the original position. In the exemplary embodiment at hand, actuating element 160 represents an actuable spindle which may be used to rotate locking bar 120. In other exemplary embodiments, however, this actuating element 160 may also be a simple motor, an adjustable spring or a magnet for moving actuating element 160.

If the wheel is in such a position that a spoke 180 is situated between movable locking bar 120 and (locking bar) receptacle 130 during the locking, then a locking operation automatically initiated by control element 160 will no longer be possible. To remedy this problem, a detection unit 190 checks in the present invention whether the travel path to be overcome by the blocking element or locking bar 120 in order to reach the (opposite lying) receptacle is blocked by a spoke 180. The control of control element 160 for the purpose of closing locking bar 120 takes place only if detection unit 190 has detected an unobstructed path and the wheel is therefore able to be blocked. In addition to the energy-saving actuation, this furthermore prevents that locking bar 120 has an adverse mechanical effect on spoke 180 or even damages it.

For optimal monitoring of the path of the blocking element, detection unit 190 may be mounted directly on housing 110, across from receptacle 130. However, it is also possible to provide the detection unit as part of the blocking element, such as directly at the front end. Optical, electrical, magnetic and/or mechanical sensors may be used as detection units, such as Hall-effect sensors, LEDs, solar cells, optical waveguides etc.

The control of the locking mechanism can be explained on the basis of the block diagram in FIG. 2. A central control unit 200 is provided, which is preferably accommodated in the locking device but may also be disposed externally, e.g., on the handle bar of the bicycle, in combination with a control element for an electrical bike. This control unit 200 has a processing unit 210, which receives the locking request through an external input 220, e.g., by a remote control or a controller on the handle bars of the bicycle. Depending on this locking request, processing unit 210 detects via detection unit 230 whether the path for the blocking element is free or blocked by an obstacle, such as a spoke. If no obstacle is detected, then control element 250 or the actuator is controlled accordingly. If the path is blocked, the control is prevented and the driver is possibly informed that the bicycle has not (yet) been locked by an optical and/or acoustic warning, e.g., using a display 270. Optionally, the check to ascertain to what extent the obstacle continues to block the path may take place repeatedly in the further course, so that the locking operation can be initiated once the wheel is in a suitable position.

In one other exemplary embodiment, it is possible that when an obstacle, in particular a spoke, is detected in the movement path of the blocking element, processing unit 210 briefly controls a drive unit 260 of the (electrical) bicycle, e.g., an electric motor, in order to intentionally rotate the spoke out of the way. Since this constitutes only a negligible wheel movement, it requires no essential drive torque. As an alternative, drive unit 260 may also initiate a type of rocking step, so that the blocking element is able to pass through either before or after the spoke.

Optionally, it is possible that additional parameters are read in by one or multiple suitable sensor(s). For example, it can be detected whether the bicycle is still moving while the locking request of the driver arrives. In this case, triggering of control element 250 by processing unit 210 is prevented even if a (briefly) unobstructed path for the blocking element is detected, in an effort to eliminate the risk of a fall.

What is claimed is:

1. An anti-theft device able to be used on a bicycle, comprising:
a control unit;
an electrically actuatable locking device for blocking a wheel of the bicycle; and
a detection unit for detecting whether the blocking of the wheel by the locking device is possible according to a blocking possibility, wherein the control unit actuates the locking device as a function of the blocking possibility.

2. The device as recited in claim 1, wherein the detection unit detects an obstacle in a blocking path of a blocking element.

3. The device as recited in claim 1, further comprising:
an electromechanical control device, wherein the locking device includes a blocking element which is able to be moved by the electromechanical control device so that blocking of the wheel takes place.

4. The device as recited in claim 3, wherein the blocking element includes one of a locking bar and a bolt.

5. The device as recited in claim 2, wherein:
the detection unit detects a position of at least one spoke of the wheel in the blocking path of the blocking element, and
the control unit actuates the locking device only if no obstacle is situated in a movement direction of the blocking element.

6. The device as recited in claim 5, wherein the control unit actuates the locking device only if no spoke is situated in the movement direction of the blocking element.

7. The device as recited in claim 3, wherein:
the electromechanical control device includes one of a motor, a spindle, a spring, and a magnet, and
an activation of the electromechanical control device generates a movement of the blocking element.

8. The device as recited in claim 1, wherein, depending on the detection of the blocking possibility, the control unit recognizes that blocking of the wheel by the locking device is not possible and controls a drive unit situated on a bicycle in such a way that the wheel on which the locking device is mountable is moved into a position in which the locking device is able to block.

9. The device as recited in claim 8, wherein the bicycle includes an electric bicycle.

10. A method for activating an anti-theft device on a bicycle, comprising:
activating a locking device to block a wheel of the bicycle; and
detecting a possibility of blocking the wheel by the locking device, wherein the locking device is activated as a function of the blocking possibility.

11. The method as recited in claim 10, wherein the locking device includes a blocking element which is able to be moved with the aid of a control device so that blocking of the wheel occurs, the locking device being activated only if no obstacle is detected in the blocking path.

12. The method as recited in claim 10, further comprising:
activating a drive unit of the bicycle as a function of the detection of the blocking possibility, which drives the wheel in order to bring the wheel into a position in which blocking by the locking device is possible.

13. A bicycle, comprising:
a device including:
a control unit;
an electrically actuatable locking device for blocking a wheel of the bicycle; and
a detection unit for detecting whether the blocking of the wheel by the locking device is possible according to a blocking possibility, wherein the control unit actuates the locking device as a function of the blocking possibility.

14. The bicycle as recited in claim 13, wherein the bicycle includes an electric bicycle.

15. The bicycle as recited in claim 13, further comprising:
a drive unit for at least partially applying a drive torque at the wheel, wherein, during an activation of the locking device, depending on a detection of the blocking possibility, the wheel is brought into a position in which blocking of the wheel by the locking device is possible.
